(19) United States
(12) Patent Application Publication
(10) Pub. No.: US 2026/0223092 A1
(43) Pub. Date: Jul. 30, 2026

(54) CHANGE OF LOGICAL CHANNEL PRIORITIZATION CRITERIA

(71) Applicant: Nokia Technologies Oy, Espoo (FI)

(72) Inventors: Carlos Santiago MOREJON GARCIA, Massy (FR); Abolfazl AMIRI, Aalborg (DK); Benoist Pierre SEBIRE, Tokyo (JP); Chunli WU, Beijing (CN)

(21) Appl. No.: 19/146,855

(22) PCT Filed: Feb. 1, 2023
(86) PCT No.: PCT/CN2023/074147

§ 371 Date: Jul. 9, 2025

(51) Int. Cl. H04W 72/0453; H04W 72/21; H04W 72/231; H04W 72/563; H04W 76/20

(52) U.S. Cl. CPC H04W 72/0453; H04W 72/21; H04W 72/231; H04W 72/563; H04W 76/20

(57) ABSTRACT

Example embodiments of the present disclosure relate to apparatuses, methods, and computer readable storage medium for change of logical channel prioritization (LCP) criteria. In a method, an apparatus receives a configuration associated with changing of at least one criterion of a LCP configuration. The apparatus then receives an indication whether the at least one criterion of the LCP configuration is to be enabled, disabled, or adjusted. Based on the indication, the apparatus performs communications.

### FIELDS

Various example embodiments of the present disclosure generally relate to the field of telecommunication and in particular, to apparatuses, methods, and computer readable storage medium for change of logical channel prioritization (LCP) criteria.

### BACKGROUND

EXtended Reality (XR) and Cloud Gaming (CG) are use cases and services which may be considered important for New Radio (NR) in the third-generation partnership project (3GPP) Release 18 (Rel-18) and beyond. Although XR and CG present a set of attractive use cases for future mobile systems, they impose a set of challenges for NR. For example, both DL and UL traffic in the XR and CG use cases are characterized by a relatively strict packet delay budget (PDB).

In addition, in NR, Logical Channel Prioritization (LCP) may be applied where a prioritized bit rate (PBR) may be added to each logical channel (LCH). Some LCP enhancements may be designed to better support such challenging services as the XR and CG use cases.

### SUMMARY

In a first aspect of the present disclosure, there is provided an apparatus. The apparatus comprises at least one processor; and at least one memory storing instructions that, when executed by the at least one processor, cause the apparatus at least to perform: receiving a configuration associated with changing of at least one criterion of a logical channel prioritization (LCP) configuration; receiving an indication whether the at least one criterion of the LCP configuration is to be enabled, disabled, or adjusted; and performing communications based on the indication.

In a second aspect of the present disclosure, there is provided an apparatus. The apparatus comprises at least one processor; and at least one memory storing instructions that, when executed by the at least one processor, cause the apparatus at least to perform: transmitting, to a further apparatus, a configuration associated with changing of at least one criterion of a logical channel prioritization (LCP) configuration; and transmitting, to the further apparatus, an indication whether the at least one criterion of the LCP configuration is to be enabled, disabled, or adjusted.

In a third aspect of the present disclosure, there is provided a method. The method comprises: at an apparatus, receiving a configuration associated with changing of at least one criterion of a logical channel prioritization (LCP) configuration; receiving an indication whether the at least one criterion of the LCP configuration is to be enabled, disabled, or adjusted; and performing communications based on the indication.

In a fourth aspect of the present disclosure, there is provided a method. The method comprises: at an apparatus, transmitting, to a further apparatus, a configuration associated with changing of at least one criterion of a logical channel prioritization (LCP) configuration; and transmitting, to the further apparatus, an indication whether the at least one criterion of the LCP configuration is to be enabled, disabled, or adjusted.

In a fifth aspect of the present disclosure, there is provided an apparatus. The first apparatus comprises means for receiving a configuration associated with changing of at least one criterion of a logical channel prioritization (LCP) configuration; means for receiving an indication whether the at least one criterion of the LCP configuration is to be enabled, disabled, or adjusted; and means for performing communications based on the indication.

In a sixth aspect of the present disclosure, there is provided an apparatus. The second apparatus comprises means for transmitting, to a further apparatus, a configuration associated with changing of at least one criterion of a logical channel prioritization (LCP) configuration; and means for transmitting, to the further apparatus, an indication whether the at least one criterion of the LCP configuration is to be enabled, disabled, or adjusted.

In a seventh aspect of the present disclosure, there is provided a computer readable medium. The computer readable medium comprises instructions stored thereon for causing an apparatus to perform at least the method according to the third or fourth aspect.

In an eighth aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling diagram between two apparatuses according to some example embodiments of the present disclosure;

FIG. 3 illustrates signaling diagram of LCP criteria change according to some example embodiments of the present disclosure;

FIG. 4 illustrates a flowchart of a method according to some example embodiments of the present disclosure;

FIG. 5 illustrates a flowchart of a method according to some other example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. As described above, extended Reality (XR) and Cloud Gaming (CG) are use cases and services which may be considered important for NR. XR and CG relate to various types of augmented, virtual, and mixed environments, where human-to-machine and human-to-human communications are performed with the assistance of handheld and wearable end user devices (UEs). For example, CG may be the group of use cases, where majority of computations related to gaming (single-player or multi-player) is offloaded from the UE to edge or remote server(s). XR may involve multiple heterogeneous use cases and services which may be divided into: (i) augmented reality (AR); (ii) virtual reality (VR), and (iii) mixed reality (MR).

XR and CG present a set of attractive use cases for future mobile systems, which impose a set of challenges for NR. For example, many of the XR and CG use cases are characterized by quasi-periodic traffic (with possible jitter) with high data rate in downlink (DL) (for example, a video stream) combined with the frequent uplink (UL) traffic (for example, pose/control update and/or a video stream). Both DL and UL traffic are also characterized by a relatively strict packet delay budget (PDB). Hence, there is a need to study and potentially specify possible solutions to better support such challenging services.

The set of anticipated XR and CG services has a certain variety and characteristics of the data streams (such as video) may change “on-the-fly”, while the services are running over NR. Therefore, additional information on the running services from higher layers, such as quality of service (QoS) flow association, frame-level QoS, application data unit (ADU)-based QoS, and XR specific QoS, may be beneficial to facilitate informed choices of radio parameters. XR application awareness by the UE and a gNB may improve user experience, improve NR system capacity in supporting XR services, and reduce UE power consumption. It is expected to identify necessary enhancements to improve XR awareness. Thus, a network (NW) will be made aware of enhanced parameters and can potentially tailor the radio processing of XR traffic.

An objective on XR-awareness may be to identify the XR traffic (both UL and DL) characteristics, QoS metrics, and application layer attributes beneficial for the gNB to be aware of and identifying how the above information aids XR-specific traffic handling. An objective on XR-specific power saving may be to design XR specific power saving techniques to accommodate XR service characteristics such as periodicity, multiple flows, jitter, latency, reliability, and/or the like. Focus may be on the following techniques: connected mode discontinuous reception (C-DRX) enhancement and Physical Downlink Control Channel (PDCCH) monitoring enhancement. An objective on XR-specific capacity improvements may be to design mechanisms that provide more efficient resource allocation and scheduling for the XR service characteristics, for example, in terms of semi-persistent scheduling (SPS) and configuration grant enhancements, and/or dynamic scheduling and grant enhancements.

In NR, LCP may be applied which may comprise two loops: a first one to serve all PBRs of all logical channels in order of priority, and a second one to use a space, which is left from a grant, in order of priority.

The legacy LCP was designed to take the priority of LCHs into account and avoid starving low-priority LCHs simultaneously. Some LCP enhancements may take a Protocol Data Unit (PDU) set delay budget (PSDB) or remaining time into account to prioritize certain data other than following the rules defined in legacy. Herein, a PDU Set may comprise one or more PDUs carrying the payload of one unit of information generated at the application level (for example, a frame or video slice for XR Services). However, overriding those legacy rules for XR may cause a problem that the QoS of data radio bearers (DRBs) may not be met when the NW needs to allocate more resources later due to congestion, which may lead to too long delays for the high-priority data.

Example embodiments of the present disclosure propose a scheme to change certain criteria in LCP. With the scheme, a mechanism with respect to changing of at least one criterion of a LCP configuration is configured, for example, to enable or disable certain LCP criteria. As an example, the criteria may comprise a delay criterion which takes a delay budget or remaining time into account to prioritize the data in an LCP procedure. Other criteria are possible as well. Then, the at least one criterion for the LCP configuration can be changed (for example, enabled, disabled, or adjusted) on the fly.

This may be done both via Radio Resource Control (RRC) and via a media access control (MAC) control element (CE). For example, a semi-static configuration via RRC may be used to configure a mechanism to enable or disable certain criteria of the LCP configuration. Dynamic control via a MAC CE or downlink control information (DCI) may be used to signal whether certain criteria of the LCP configuration is to be enabled, disabled, or adjusted.

In this way, the LCP configuration may be changed, for example, according to QoS or application requirements or according to network deployment, which may be more flexible and efficient in LCP.

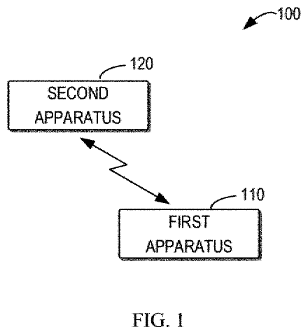

FIG. 1 illustrates an example communication environment 100 in which example embodiments of the present disclosure can be implemented. In the communication environment 100, a plurality of communication devices, including a first apparatus 110 and a second apparatus 120, can communicate with each other.

In the following, for the purpose of illustration, some example embodiments are described with the first apparatus 110 operating as a terminal device such as a UE and the second apparatus 120 operating as a network device such as a gNB. However, in some example embodiments, operations described in connection with a terminal device may be implemented at a network device or other devices, and operations described in connection with a network device may be implemented at a terminal device or other devices.

In some example embodiments, if the first apparatus 110 is a terminal device and the second apparatus 120 is a network device, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver). In some example embodiments, both the first and second apparatuses 110 and 120 may be terminal devices which can communicate with each other in Sidelink (SL).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of apparatuses are only for the purpose of illustration without suggesting any limitations. The communication environment 100 may include any suitable numbers of apparatuses for implementing embodiments of the present disclosure.

In the environment 100, the first apparatus 110 may be configured with LCP. During an LCP procedure, data with different priority may be served with different logical channels with different LCH priority. In a scenario where a PDU set of low importance is mapped to an LCH with low priority, it may be possible that some PDUs of the PDU set may have been transmitted in a Transport block (TB) while other PDUs in the PDU set may be remaining in the LCH buffer. If the first apparatus 110 receives a PDU set of high importance that is mapped to an LCH with high priority, the first apparatus 110 may include the PDUs of the high-priority PDU set into the TB first even if the PSDB of the high-priority PDU set is still large while the PSDB of the low-priority PDU set is fast approaching.

In some example embodiments, the remaining PDB of the data buffered in the LCH may be considered as a criterion during the LCP procedure. For example, even if the priority of an LCH is low, if the remaining time of the data buffered in the LCH is small, this LCH may be transmitted prior to other LCHs. Some other criteria may also be considered in LCP, which may be associated with PDU set importance, PDU set boundary (for example, whether the last PDU of PDU set is received), power saving, and/or the like.

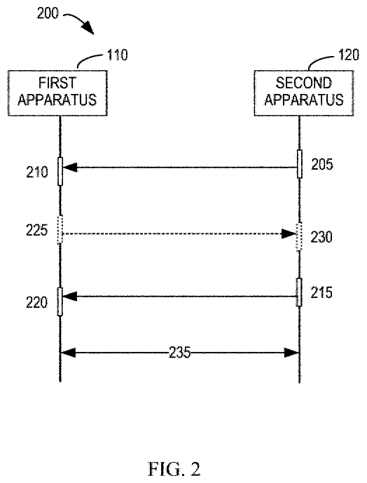

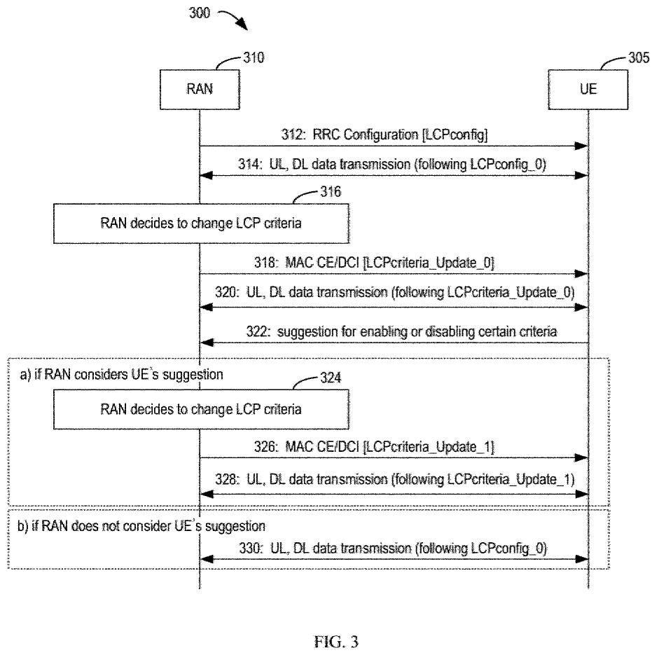

In various example embodiments, at least one criterion of an LCP configuration for the first apparatus 110 can be changed according to configurations and indications from the network such as the second apparatus 120. Some example implementations will be discussed below with reference to FIGS. 2 and 3.

FIG. 2 shows a signaling diagram 200 between the first apparatus 110 and the second apparatus 120 according to some example embodiments of the present disclosure. For the purpose of discussion, the signaling diagram 200 will be described with reference to FIG. 1.

As shown in FIG. 2, the second apparatus 120 (such as a gNB) transmits (205), to the first apparatus 110 (such as a UE), a configuration associated with changing of at least one criterion of a LCP configuration. The configuration may comprise a flag to enable the changing of the at least one criterion of the LCP configuration. The flag may indicate if a mechanism to enable or disable certain criteria in LCP is enabled or disabled, so as to configure the mechanism. In some example embodiments, the configuration may comprise one or more criteria for evaluation on the enabling or disabling of the mechanism, which may be subject to the application requirements, for example, PDU-set differentiation in the XR services. Such a flag and criteria may be signaled by the network based on the corresponding requirements.

Alternatively, or in addition, the configuration may comprise a set of criteria for the LCP configuration, which may be represented by a vector. The criteria may be related to various aspects of the LCP procedure and may involve various parameters. In some example embodiments, the at least one criterion may comprise a delay criterion that a delay budget may be activated for the LCP. In one example, it may be specified that the delay criterion is taking PSDB or remaining time into account to prioritize the data in LCP.

In some example embodiments, the delay criterion may be considered for LCHs with the same priority, a LCH with a predetermined priority, and/or a LCH with a priority within a predetermined priority range. As an example, the delay criterion may apply only to the LCHs with the same priority. In one example, for multiple LCHs with the same priority, the UE prioritizes the data of the LCH with the least remaining time. Alternatively, or in addition, it may be configured as applicable only to the LCHs with certain priority(ies) or within a certain priority range.

Some other criteria may also be considered in LCP. The scope of the present disclosure will not be limited in this regard. As an example, the criteria may be associated with PDU set importance, PDU set boundary (for example, whether the last PDU of PDU set is received), and/or the like.

In some example embodiments, the configuration may comprise association of values of a tag to different criteria of the LCP configuration, different subsets of criteria of the LCP configuration, or different LCP configurations with different criteria. As such, the network may associate a tag to different criteria, different subsets of criteria, or different LCP configurations.

In some example embodiments, the configuration may comprise a default criterion of the LCP configuration, which may be configured based on the QoS requirements of the PDU set. In this way, more efficient LCP procedure may be provided to the first apparatus 110.

Alternatively, or in addition, the configuration may comprise a bit or bitmap indicating whether changing of one or more features of the at least one criterion is enabled or disabled. Thus, each feature of the criterion may be enabled or disabled. In this way, the criterion may be controlled per feature.

In some example embodiments, the changing of the at least one criterion for the LCP configuration may be changed per control granularity. In this example, the configuration may comprise control granularity for enabling the changing of the at least one criterion. The control granularity may indicate that the changing of the at least one criterion is enabled for the first apparatus 110, a logical channel (LCH), a logical channel group (LCG), a radio bearer (RB) such as a data radio bearer (DRB) and a signaling radio bearer (SRB), and/or a quality-of-service (QoS) flow. Thus, the control granularity for the enabling or disabling of the criteria may be per UE, LCH, LCG, DRB/SRB, QoS flow, and/or the like.

Upon the transmission of the configuration by the second apparatus 120, as shown in FIG. 2, the first apparatus 110 receives (210) the configuration associated with changing of at least one criterion of the LCP configuration. In some example embodiments, the configuration may be received by the first apparatus 110 in RRC signaling. Such a configuration may be a semi-static configuration via RRC. Thus, a mechanism to change the LCP criteria may be enabled in a semi-static way, which may be more flexible.

Then, the second apparatus 120 transmits (215) to the first apparatus 110 an indication whether the at least one criterion of the LCP configuration is to be enabled, disabled, or adjusted. Accordingly, the first apparatus 110 receives (220) this indication. Such an indication may be transmitted in a media access control (MAC) control element (CE) or downlink control information (DCI). In this way, the network may dynamically adjust, enable, or disable the parameters specified in the semi-static configuration. Thus, the LCP criteria may be dynamically controlled via a MAC CE or DCI.

The indication may be implemented in any suitable form. For example, in the example embodiments where the semi-static configuration associates a tag to different criteria, subset of criteria or LCP configurations, a value of the values of the tag may be used to indicate activation of the associated one or more criteria. Thus, the criteria of the LCP configuration may be changed in more flexible and efficient way.

In some example embodiments, the delay criteria-based LCP may be enabled dynamically according to the traffic requirements and radio conditions. For example, if the network is congested or overloaded, the prioritization of low-priority data with small PDB over the high-priority data in the delay criteria-based LCP may finally lead to too long delays for both the low-priority data and the high-priority data. The dynamic enabling of the delay criterion may improve the transmission efficiency in LCP.

In some example embodiments, as shown in FIG. 2, the first apparatus 110 may transmit (225) to the second apparatus 120 a suggestion for changing the at least one criterion of the LCP configuration. Such a suggestion may be transmitted in RRC signaling, a MAC CE or uplink control information (UCI). As such, the first apparatus 110 such as a UE may be allowed to suggest enabling or disabling certain criteria via RRC, a MAC CE or UCI. Thus, the LCP criteria may be changed based on UE's needs or requirements.

After receiving (230) the suggestion from the first apparatus 110, the second apparatus 120 may or may not consider this suggestion. In some example embodiments, the second apparatus 120 may determine, based on the suggestion, whether the at least one criterion of the LCP configuration is to be enabled, disabled, or adjusted. Accordingly, in response to transmitting (225) the suggestion, the first apparatus 110 may receive the indication whether the at least one criterion of the LCP configuration is to be enabled, disabled, or adjusted.

Based on the indication, the first apparatus 110 performs (235) communication, for example, with the second apparatus 120. It is to be understood that the semi-static configuration and the dynamic indication are shown in FIG. 2 to be received by the first apparatus 110 from the second apparatus 120 only for the purpose of illustration without suggestion. The first apparatus 110, which may be a UE, may receive such a configuration and an indication from one or more other devices such as other UEs or gNBs, and then use the indication to communicate with the second apparatus 120 or another apparatus which may a terminal device or a network device.

An example process of signaling exchange to enable or disable the mechanism and the criteria information will be discussed below with reference to FIG. 3.

FIG. 3 shows a signaling diagram 300 of LCP criteria change according to some example embodiments of the present disclosure. In this example, the first apparatus 110 may be a UE 305, and the LCP configuration is provided to the first apparatus 110 from a radio access network (RAN) 310, for example, via a gNB which may be an example of the second apparatus 120.

As shown in FIG. 3, at 312, a RRC configuration with LCP criteria change enabled is transmitted from the RAN 310 to the UE 305. New configurations regarding the LCP criteria may be defined as LCPconfig, for example. For instance, the parameter LCPconfig may include a flag to enable the change of criterion, a vector for the set of criteria (for example, including a delay budget), a bit or bitmap indicating each feature is enabled or disabled or per feature control, a default criterion, and/or control granularity. LCPconfig may include either change of certain parameters within the configuration (such as a bit or bitmap indicating each feature is enabled or disabled) or a list of all configuration parameters. At 314, UL and/or DL data transmission between the RAN 310 (for example, a gNB) and the UE 305 may follow the configuration detailed in LCPconfig.

At 316, the RAN 310 may decide to change the LCP criteria. At 318, the RAN 310 may signal the updates to the LCPconfig via LCPcriteria_Update_0 to the UE 305. For instance, the RAN 310 may enable the delay criteria-based LCP. Such information may be sent via, for example, MAC CE or DCI. Then, at 320, the RAN 310 and the UE 305 may follow the configuration detailed in LCPcriteria_Update_0.

At 322, the UE 305 may suggest changing the LCP configuration. For instance, the UE 305 may want to disable delay criteria for LCP (for example, via UCI, MAC CE or RRC). If the RAN 310 considers UE's suggestion, at 324, the RAN may decide to change the LCP criteria. At 326, the RAN 310 may signal the updates to the LCPconfig via LCPcriteria_Update_1 to the UE 305. At 328, the RAN 310 and the UE 305 may follow the configuration detailed in LCPcriteria_Update_1. If the RAN 210 does not consider UE's suggestion, the RAN 310 and the UE 305 may follow the configuration detailed in LCPcriteria_Update_0 (that is, the RAN 310 may ignore the UE's suggestion).

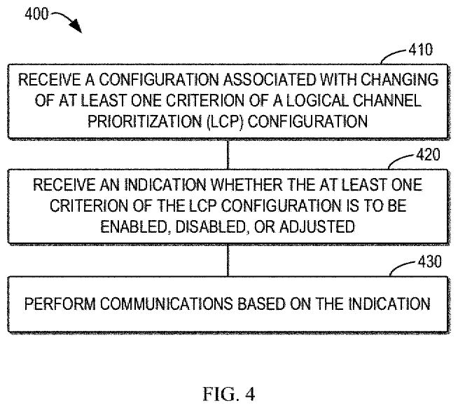

FIG. 4 shows a flowchart of an example method 400 in accordance with some example embodiments of the present disclosure. The method 400 may be implemented at either the first apparatus 110 or the second apparatus 120 as shown in FIG. 1. For the purpose of discussion, the method 400 will be described from the perspective of the first apparatus 110 in FIG. 1.

At block 410, the first apparatus 110 receives a configuration associated with changing of at least one criterion of a logical channel prioritization (LCP) configuration. At block 420, the first apparatus 110 receives an indication whether the at least one criterion of the LCP configuration is to be enabled, disabled, or adjusted. At block 430, the first apparatus 110 performs communications based on the indication.

In some example embodiments, the configuration may comprise at least one of: a flag to enable the changing of the at least one criterion of the LCP configuration; a bit or bitmap indicating whether changing of one or more features of the at least one criterion is enabled or disabled, a default criterion of the LCP configuration, or control granularity for enabling the changing of the at least one criterion.

In some example embodiments, the control granularity may indicate that the changing of the at least one criterion is enabled for at least one of: the first apparatus 110, a logical channel, a logical channel group, a radio bearer, or a quality-of-service flow.

In some example embodiments, the configuration may comprise association of values of a tag with different criteria of the LCP configuration, different subsets of criteria of the LCP configuration, or different LCP configurations with different criteria. In these example embodiments, the first apparatus 110 may receive a value of the values of the tag to indicate activation of the associated one or more criteria.

In some example embodiments, the configuration may be received in radio resource control (RRC) signaling. Alternatively, or in addition, the indication may received in a media access control (MAC) control element (CE), or downlink control information (DCI).

In some example embodiments, the at least one criterion may comprise a delay criterion that a delay budget is considered for: logical channels with the same priority, a logical channel with a predetermined priority, and/or a logical channel with a priority within a predetermined priority range.

In some example embodiments, the first apparatus 110 may transmit, to a further apparatus such as the second apparatus 120, a suggestion for changing the at least one criterion of the LCP configuration. In some example embodiments, in response to transmitting the suggestion, the first apparatus 110 may receive the indication from the further apparatus. In some example embodiments, the suggestion may be transmitted in radio resource control (RRC) signaling, a media access control (MAC) control element (CE), or uplink control information (UCI).

All operations and features related to the first apparatus 110 as described above with reference to FIGS. 1 and 2 and the UE 305 as described above with reference to FIG. 3 are likewise applicable to the method 400 and have similar effects. For the purpose of simplification, the details will be omitted.

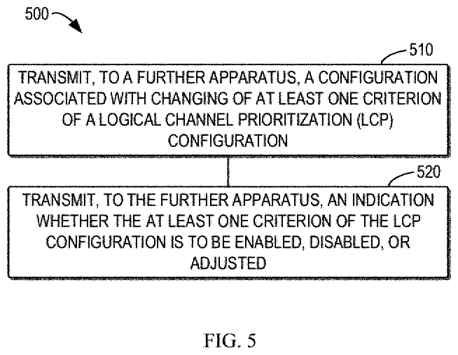

FIG. 5 shows a flowchart of an example method 500 in accordance with some other example embodiments of the present disclosure. The method 500 may be implemented at either the first apparatus 110 or the second apparatus 120 as shown in FIG. 1. For the purpose of discussion, the method 500 will be described from the perspective of the second apparatus 120 in FIG. 1.

At block 510, the second apparatus 120 transmits, to a further apparatus such as the first apparatus 110, a configuration associated with changing of at least one criterion of a logical channel prioritization (LCP) configuration. At block 520, the second apparatus 120 transmits, to the further apparatus, an indication whether the at least one criterion of the LCP configuration is to be enabled, disabled, or adjusted.

In some example embodiments, the configuration may comprise at least one of: a flag to enable the changing of the at least one criterion of the LCP configuration; a bit or bitmap indicating whether changing of one or more features of the at least one criterion is enabled or disabled, a default criterion of the LCP configuration, or control granularity for enabling the changing of the at least one criterion.

In some example embodiments, the control granularity may indicate that the changing of the at least one criterion is enabled for at least one of: the further apparatus, a logical channel, a logical channel group, a radio bearer, or a quality-of-service flow.

In some example embodiments, the configuration may comprise association of values of a tag with different criteria of the LCP configuration, different subsets of criteria of the LCP configuration, or different LCP configurations with different criteria, and transmitting the indication comprises: transmitting a value of the values of the tag to indicate activation of the associated one or more criteria.

In some example embodiments, the configuration may be transmitted in radio resource control (RRC) signaling; and/or the indication is transmitted in a media access control (MAC) control element (CE), or downlink control information (DCI).

In some example embodiments, the at least one criterion may comprise a delay criterion that a delay budget is considered for: logical channels with the same priority, a logical channel with a predetermined priority, and/or a logical channel with a priority within a predetermined priority range.

In some example embodiments, the second apparatus 120 may receive, from the further apparatus such as the first apparatus 110, a suggestion for changing the at least one criterion of the LCP configuration. In some example embodiments, the second apparatus 120 may determine, based on the suggestion, whether the at least one criterion of the LCP configuration is to be enabled, disabled, or adjusted. In some example embodiments, the suggestion may be received in radio resource control (RRC) signaling, a media access control (MAC) control element (CE), or uplink control information (UCI).

All operations and features related to the second apparatus 120 as described above with reference to FIGS. 1 and 2 and the RAN 310 as described above with reference to FIG. 3 are likewise applicable to the method 500 and have similar effects. For the purpose of simplification, the details will be omitted.

In some example embodiments, an apparatus capable of performing any of the method 400 (for example, the first apparatus 110 in FIG. 1 may comprise means for performing the respective operations of the method 400. The means may be implemented in any suitable form. For example, the means may be implemented in a circuitry or software module. The first apparatus may be implemented as or included in the first apparatus 110 in FIG. 1.

In some example embodiments, the apparatus comprises means for receiving a configuration associated with changing of at least one criterion of a logical channel prioritization (LCP) configuration; means for receiving an indication whether the at least one criterion of the LCP configuration is to be enabled, disabled, or adjusted; and means for performing communications based on the indication.

In some example embodiments, the configuration comprises at least one of: a flag to enable the changing of the at least one criterion of the LCP configuration; a bit or bitmap indicating whether changing of one or more features of the at least one criterion is enabled or disabled, a default criterion of the LCP configuration, or control granularity for enabling the changing of the at least one criterion.

In some example embodiments, the control granularity indicates that the changing of the at least one criterion is enabled for at least one of: the apparatus, a logical channel, a logical channel group, a radio bearer, or a quality-of-service flow.

In some example embodiments, the configuration comprises association of values of a tag with different criteria of the LCP configuration, different subsets of criteria of the LCP configuration, or different LCP configurations with different criteria, and the means for receiving the indication comprises: means for receiving a value of the values of the tag to indicate activation of the associated one or more criteria.

In some example embodiments, the configuration is received in radio resource control (RRC) signaling; and/or the indication is received in a media access control (MAC) control element (CE), or downlink control information (DCI).

In some example embodiments, the at least one criterion comprises a delay criterion that a delay budget is considered for: logical channels with the same priority, a logical channel with a predetermined priority, and/or a logical channel with a priority within a predetermined priority range.

In some example embodiments, the first apparatus further comprises: means for transmitting, to a further apparatus, a suggestion for changing the at least one criterion of the LCP configuration.

In some example embodiments, the means for receiving the indication comprises: means for in response to transmitting the suggestion, receiving the indication from the further apparatus.

In some example embodiments, the suggestion is transmitted in radio resource control (RRC) signaling, a media access control (MAC) control element (CE), or uplink control information (UCI).

In some example embodiments, the apparatus further comprises means for performing other operations in some example embodiments of the method 400 or the first apparatus 110. In some example embodiments, the means comprises at least one processor; and at least one memory storing instructions that, when executed by the at least one processor, cause the performance of the apparatus.

In some example embodiments, an apparatus capable of performing any of the method 500 (for example, the second apparatus 120 in FIG. 1 may comprise means for performing the respective operations of the method 500. The means may be implemented in any suitable form. For example, the means may be implemented in a circuitry or software module. The apparatus may be implemented as or included in the second apparatus 120 in FIG. 1.

In some example embodiments, the apparatus comprises means for transmitting, to a further apparatus, a configuration associated with changing of at least one criterion of a logical channel prioritization (LCP) configuration; and means for transmitting, to the further apparatus, an indication whether the at least one criterion of the LCP configuration is to be enabled, disabled, or adjusted.

In some example embodiments, the configuration comprises at least one of: a flag to enable the changing of the at least one criterion of the LCP configuration; a bit or bitmap indicating whether changing of one or more features of the at least one criterion is enabled or disabled, a default criterion of the LCP configuration, or control granularity for enabling the changing of the at least one criterion.

In some example embodiments, the control granularity indicates that the changing of the at least one criterion is enabled for at least one of: the further apparatus, a logical channel, a logical channel group, a radio bearer, or a quality-of-service flow.

In some example embodiments, the configuration comprises association of values of a tag with different criteria of the LCP configuration, different subsets of criteria of the LCP configuration, or different LCP configurations with different criteria, and means for transmitting the indication comprises: means for transmitting a value of the values of the tag to indicate activation of the associated one or more criteria.

In some example embodiments, the configuration is transmitted in radio resource control (RRC) signaling; and/or the indication is transmitted in a media access control (MAC) control element (CE), or downlink control information (DCI).

In some example embodiments, the at least one criterion comprises a delay criterion that a delay budget is considered for: logical channels with the same priority, a logical channel with a predetermined priority, and/or a logical channel with a priority within a predetermined priority range.

In some example embodiments, the apparatus further comprises: means for receiving, from the further apparatus, a suggestion for changing the at least one criterion of the LCP configuration.

In some example embodiments, the apparatus further comprises: means for determining, based on the suggestion, whether the at least one criterion of the LCP configuration is to be enabled, disabled, or adjusted.

In some example embodiments, the suggestion is received in radio resource control (RRC) signaling, a media access control (MAC) control element (CE), or uplink control information (UCI).

In some example embodiments, the apparatus further comprises means for performing other operations in some example embodiments of the method 500 or the second apparatus 120. In some example embodiments, the means comprises at least one processor; and at least one memory storing instructions that, when executed by the at least one processor, cause the performance of the apparatus.

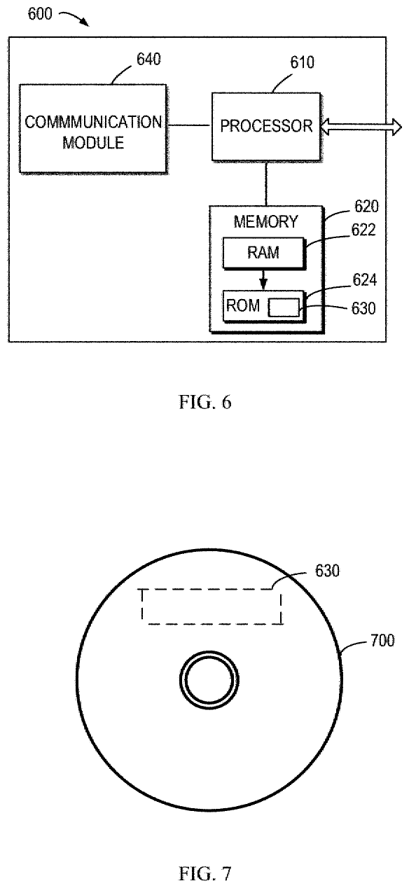

FIG. 6 is a simplified block diagram of an apparatus 600 that is suitable for implementing example embodiments of the present disclosure. The apparatus 600 may be provided to implement a communication device, for example, the first apparatus 110 or the second apparatus 120 as shown in FIG. 1. As shown, the apparatus 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The apparatus 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the apparatus 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the apparatus 600 (such as in the memory 620) or other storage devices that are accessible by the apparatus 600. The apparatus 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-39. (canceled)

40. An apparatus comprising:
at least one processor; and
at least one memory storing instructions that, when executed by the at least one processor, cause the apparatus at least to perform:
receiving a configuration associated with changing of at least one criterion of a logical channel prioritization (LCP) configuration;
receiving an indication whether the at least one criterion of the LCP configuration is to be enabled, disabled, or adjusted; and
performing communications based on the indication.

41. The apparatus of claim 40, wherein the configuration comprises at least one of:
a flag to enable the changing of the at least one criterion of the LCP configuration;
a bit or bitmap indicating whether changing of one or more features of the at least one criterion is enabled or disabled,
a default criterion of the LCP configuration, or
control granularity for enabling the changing of the at least one criterion.

42. The apparatus of claim 41, wherein the control granularity indicates that the changing of the at least one criterion is enabled for at least one of:
the apparatus,
a logical channel,
a logical channel group,
a radio bearer, or
a quality-of-service flow.

43. The apparatus of claim 40, wherein
the configuration comprises association of values of a tag with different criteria of the LCP configuration, different subsets of criteria of the LCP configuration, or different LCP configurations with different criteria, and
receiving the indication comprises:
receiving a value of the values of the tag to indicate activation of the associated one or more criteria.

44. The apparatus of claim 40, wherein
the configuration is received in radio resource control (RRC) signaling; and/or
the indication is received in a media access control (MAC) control element (CE) or downlink control information (DCI).

45. The apparatus of claim 40, wherein the at least one criterion comprises a delay criterion that a delay budget is considered for:
logical channels with the same priority,
a logical channel with a predetermined priority, and/or
a logical channel with a priority within a predetermined priority range.

46. The apparatus of claim 40, wherein the apparatus is further caused to perform:
transmitting, to a further apparatus, a suggestion for changing the at least one criterion of the LCP configuration.

47. The apparatus of claim 46, wherein receiving the indication comprises:
in response to transmitting the suggestion, receiving the indication from the further apparatus.

48. The apparatus of claim 46, wherein the suggestion is transmitted in radio resource control (RRC) signaling, a media access control (MAC) control element (CE), or uplink control information (UCI).

49. An apparatus, comprising:
at least one processor; and
at least one memory storing instructions that, when executed by the at least one processor, cause the apparatus at least to perform:
transmitting, to a further apparatus, a configuration associated with changing of at least one criterion of a logical channel prioritization (LCP) configuration; and
transmitting, to the further apparatus, an indication whether the at least one criterion of the LCP configuration is to be enabled, disabled, or adjusted.

50. The apparatus of claim 49, wherein the configuration comprises at least one of:
a flag to enable the changing of the at least one criterion of the LCP configuration;
a bit or bitmap indicating whether changing of one or more features of the at least one criterion is enabled or disabled,
a default criterion of the LCP configuration, or
control granularity for enabling the changing of the at least one criterion.

51. The apparatus of claim 50, wherein the control granularity indicates that the changing of the at least one criterion is enabled for at least one of:
the further apparatus,
a logical channel,
a logical channel group,
a radio bearer, or
a quality-of-service flow.

52. The apparatus of claim 49, wherein
the configuration comprises association of values of a tag with different criteria of the LCP configuration, different subsets of criteria of the LCP configuration, or different LCP configurations with different criteria, and
transmitting the indication comprises:
transmitting a value of the values of the tag to indicate activation of the associated one or more criteria.

53. The apparatus of claim 49, wherein
the configuration is transmitted in radio resource control (RRC) signaling; and/or
the indication is transmitted in a media access control (MAC) control element (CE), or downlink control information (DCI).

54. The apparatus of claim 49, wherein the at least one criterion comprises a delay criterion that a delay budget is considered for:
logical channels with the same priority,
a logical channel with a predetermined priority, and/or
a logical channel with a priority within a predetermined priority range.

55. The apparatus of claim 49, wherein the apparatus is further caused to perform:
receiving, from the further apparatus, a suggestion for changing the at least one criterion of the LCP configuration.

56. The apparatus of claim 55, wherein the apparatus is further caused to perform:
determining, based on the suggestion, whether the at least one criterion of the LCP configuration is to be enabled, disabled, or adjusted.

57. The apparatus of claim 55, wherein the suggestion is received in radio resource control (RRC) signaling, a media access control (MAC) control element (CE), or uplink control information (UCI).

58. A method, comprising:
receiving a configuration associated with changing of at least one criterion of a logical channel prioritization (LCP) configuration;
receiving an indication whether the at least one criterion of the LCP configuration is to be enabled, disabled, or adjusted; and
performing communications based on the indication.

59. The method of claim 58, wherein the configuration comprises at least one of:
a flag to enable the changing of the at least one criterion of the LCP configuration;
a bit or bitmap indicating whether changing of one or more features of the at least one criterion is enabled or disabled,
a default criterion of the LCP configuration, or
control granularity for enabling the changing of the at least one criterion.
